(19) United States
(12) Patent Application Publication
(10) Pub. No.: US 2015/0136034 A1
(43) Pub. Date: May 21, 2015

(54) Reusable Protective Outer Sleeve for Fully Disposable Pet Toilet Units Incorporating Living Grass

(71) Applicant: Andrew Craghan Feld, Davenport, FL (US)

(72) Inventor: Andrew Craghan Feld, Davenport, FL (US)

(21) Appl. No.: 14/121,511

(22) Filed: Sep. 15, 2014

Related U.S. Application Data
(60) Provisional application No. 61/961,238, filed on Oct. 9, 2013.

(51) Int. Cl. A01K 1/01

(52) U.S. Cl. CPC A01K 1/0107
USPC 119/161

(57) ABSTRACT

The present invention relates to a reusable outer sleeve that is made of durable material for the purpose of protecting the sidewalls and corners of a fully-disposable pet toilet unit that incorporates living grass as an absorbent material for the bodily waste of pets. The sleeve eliminates or minimizes damage that can be caused by pets who engage in biting, chewing, gnawing, clawing, pecking, ripping and/or tearing of the apparatus. When the cover of a disposable pet toilet unit is removed by the user following the unit's delivery, the bottom of said unit is placed within the sleeve before the pet uses the toilet for the first time. The bottom of the unit is removed from the sleeve when it is time to discard the disposable pet toilet. The sleeve is retained for future use with other disposable pet toilet units that fit within the sleeve.

### BACKGROUND OF THE INVENTION

On September 3, 2013, the USPTO issued U.S. Pat. No. 8,522,719 for a “Portable and Disposable Living-Grass Pet Toilet.” In commerce, the disposable container for this pet toilet invention is currently being made of corrugated cardboard, which has been manufactured—or treated subsequent to its manufacture—to be resistant to the penetration of liquids. The pet toilet unit is currently commercialized under the brand name of FRESH PATCH by Fresh Patch LLC (www.freshpatch.com). Each pet toilet is a single, integrated, self-contained unit comprised of a fully-disposable container fitted with living grass. While this pet toilet works very effectively for most pets, there are some pets—especially energetic puppies and rambunctious adult dogs—who are relentless biters, chewers, gnawers, rippers and/or tearers. Pets who exhibit these characteristics can damage the disposable bottom of the pet toilet and eventually even tear the toilet into pieces or completely apart with their incessant destructive behavior. Such destructive pet behavior compromises the utility of the pet toilet and can create a messy floor for the pet owner to clean. The present invention solves this problem by providing a reusable protective outer sleeve for the disposable bottom of the pet toilet unit in order to protect it from this type of damage and avoid a household mess. When the user removes the cover of the pet toilet unit following its delivery, the pet toilet bottom is placed within the sleeve prior to the toilet's use by a pet. The toilet's bottom remains within the sleeve throughout the pet's use of the toilet. Once the user is ready to discard the pet toilet, he or she removes the toilet's bottom from the protective sleeve, replaces the cover on the unit, and throws the unit away in its entirety. The sleeve would be retained and readied for use to protect another fully-disposable, living-grass pet toilet of a size and shape that would fit within the sleeve. The present invention would be useful and beneficial for individuals who would like to take advantage of the convenience and other positive attributes of a fully-disposable, living-grass pet toilet, but who currently may not do so because of the destructive behavior of their pets.

### DETAILED DESCRIPTION OF PREFERRED EMBODIMENT

The outer protective sleeve would have the same shape, height, and general orientation in space as the living-grass disposable pet toilet whose exterior sidewalls and corners it protects. The preferred embodiment described herein assumes that the fully-disposable, living-grass pet toilet is the shape of a rectangle, as shown in the drawings of U.S. Pat. No. 8,522,719. Based on that example, the sleeve would also be rectangular in shape and would have four sidewalls that are connected or could be connected to form a rectangle, so that the sleeve's four sidewalls would be able to surround and protect the four sidewalls of the pet toilet. The protective outer sleeve would be open at both ends such that its placement on a surface area would create a cavity into which the pet toilet unit could be placed. When the pet toilet unit is ready to be discarded, the sleeve would be lifted up over the unit and retained for use with other disposable pet toilet units of like size and shape.

The protective sleeve and/or its corners would be of a height that would equal to or greater than the sidewalls of the pet toilet unit in order to protect the unit's sidewalls from destructive pet behavior, including chewing, gnawing, and tearing.

The sleeve would be placed on a floor or other surface area in a manner and in a spatial orientation that would permit the pet toilet to be inserted into one of the openings of the sleeve so that the blades of the toilet's grass would face upward and the exterior base of the pet toilet (that is, the exterior bottom of the disposable container) would rest on or be in direct contact with said surface area. After being placed into the sleeve, the pet toilet would remain there during the toilet's use by a pet(s). When it is time to dispose of the pet toilet, either the sleeve would be raised up over the toilet so that it could be discarded, or the pet toilet would be lifted out of the sleeve for the same purpose. The sleeve would be retained for use with another fully-disposable, living-grass pet toilet. Thus, in this preferred embodiment, the sleeve consists of only four sidewalls that are connected or could be connected to form a rectangle that could surround the four sidewalls of the pet toilet, and both ends of the sleeve would be open so that the pet toilet could be easily placed into and removed from the sleeve. The process for inserting a newly delivered toilet into the sleeve, and later removing it for disposal, could take place on a continuous basis as new pet toilets are delivered to replace soiled ones.

In an alternative embodiment, only one part of the sleeve would be entirely open for the purpose of exposing the blades of the pet toilet's grass upward for use by a pet(s) for waste elimination. The other end of the sleeve would be either totally or partially closed by a base on which the pet toilet would be placed prior to use by a pet. In this embodiment, the exterior base of the pet toilet (that is, the bottom of the disposable container) would rest on the sleeve's base, and would not be in direct contact with the floor or other level surface that is used for placement of the apparatus. The sleeve's base would be either: (1) a permanent part of the sleeve that is formed during the construction process, or (2) a separate part of the sleeve. In the first example, the sleeve's base could be made to be an integral part of the sleeve unit through casting, molding, nailing, gluing or other process. In the second example, the sleeve's base may be separate and independent from the sleeve's sidewalls, or it may be temporarily connected to and disconnected from the sleeve's sidewalls with snaps, hooks, latches, bands, or other connecting/fastening devices or methods. In either of the examples given, the pet toilet would be placed inside the sleeve so that the exterior of the pet toilet's base (that is, the bottom of the disposable container) would be resting on the sleeve's base. The sleeve's base would be made of cloth, canvas, plastic, wood, metal, composite material, or a combination of materials that form a solid, slatted, meshed, trellis-like, or perforated surface. The sleeve's base would form 90 degree angles with the sleeve's interior sidewalls—creating an aperture into which the disposable pet toilet could be easily placed so that the exterior base of the pet toilet (that is, the bottom of the disposable container) would be resting on the sleeve's base. The sleeve's base may be on the same plane as the sleeve's sidewalls, or may be slightly raised from that plane in order to facilitate the circulation of air beneath the disposable pet toilet when it is placed within the sleeve.

In another alternative embodiment, one of the sleeve's sidewalls may be constructed so that it can moved aside or totally removed, on a temporary basis, in order to facilitate the placement of the disposable pet toilet into the sleeve and its subsequent removal at disposal time. To that end, the sleeve may have a hinge-like device(s)—which may or may not be in combination with a latch-like device(s)—on one or more of its sidewalls to enable one of the sidewalls to open in the manner akin to either a single door or a double door. If a hinge-like device(s) is used—with or without a latch-like device(s)—it may be placed so that the sleeve's sidewall may open in a particular direction—downward, upward, to the right, to the left, or from the middle outward. Alternatively, one of the sleeve's sidewalls may be constructed in the form of a slat or slats that can be moved along grooves, channels, ridges, other indentations, or lips that have been fashioned in one or more of the sleeve's stationary sidewalls. Wheel-like or roller-like devices may be used to facilitate the sliding motion of the slat(s). The sliding of the slat(s) would temporarily move that one sidewall out of its contiguous position relative to other sidewalls, thus creating an opening through which the pet toilet could be easily slid into and out of the sleeve. The sidewall that is constructed as a slat(s) could be moved in a particular direction along the grooves, channels, ridges, other indentations, or lips of the sleeve—for example, upward, downward, to the left, to the right, or, if the slat has two pieces, from the middle outward—in order to achieve the result of creating a temporary opening on one side of the sleeve. The slat(s) could also be constructed to function in an accordion-like fashion similar to a window blind that can be raised and lowered, so that the slat(s) could be collapsed to create a temporary opening for sliding the pet toilet into and out of the sleeve.

In the embodiment in which one of the sleeve's sidewalls is a movable slat(s), the base of the sleeve may be a tray-like or shelf-like element that can be slid into and out of the sleeve by moving it—with or without wheel-like devices—along channels, grooves, ridges, other indentations, lips or similar configurations that are on the sleeve's interior sidewalls, or by simply sliding the element along the floor or other surface on which the sleeve has been placed. To elaborate, when the sidewall that functions as a slat(s) is temporarily opened, the pet toilet would be placed on the tray-like or shelf-like element so that it could easily be slid into and out of that temporary opening of the sleeve. The sliding of the tray-like or shelf-like element into and out of the sleeve would facilitate initial placement of the pet toilet into the sleeve and its later removal at disposal time. Alternatively, the tray-like or shelf-like element, on which the pet toilet would be resting, could be a separate piece or part of the sleeve that never connects with the sleeve's sidewalls, but is simply slid into and out of the sleeve by pushing or rolling it—with or without a wheel-like device—along the floor or other surface area on which the apparatus has been placed. Once the tray-like or shelf-like element on which the pet toilet is resting has been slid into the sleeve, the sidewall that is a slat(s) would be closed, and would remain closed, until such time as an individual wanted to discard the toilet due to its extended use by a pet(s), and he or she would therefore once again open the sidewall temporarily. A variation on this embodiment would be to construct the tray-like or shelf-like element in an “L” -like shape such that the vertical part of the “L” can function as a movable sidewall that is connected to the horizontal tray-like or shelf-like part of the “L.” In that configuration, the “L” shaped unit, which comprises both the tray-like or shelf-like element and the movable sidewall, would be pushed in when initially placing the pet toilet into the sleeve and pulled out when removing the pet toilet for disposal. Latches or other devices may or may not be used to attach or detach the “L”-shaped element to the stationary part of the sleeve at appropriate times.

In yet another embodiment, one of the sidewalls would be constructed so that it is only partially open. Said sidewall would be constructed to protect the CORNERS of the pet toilet that are adjacent to that sidewall; however, the middle part of that sidewall would be of a height that is less than that of the sleeve's other sidewalls in order to facilitate the pet's entry into and exit from the pet toilet, as well as the initial placement into and subsequent removal of the pet toilet from the sleeve. In this construction, the middle of that one sidewall would likely be in a shape resembling the letter “u”—in either a rounded or square-shaped representation.

In any of the embodiments described, the protective sleeve could be used to display the pet's name. The name could be painted on the sleeve, or displayed on a plate, panel or label made of metal, plastic, pottery or similar durable material that could be affixed to an exterior sidewall of the sleeve.

The applicant notes that, because the present invention is unique to living-grass disposable pet toilets, it could not have existed prior to the invention recognized by U.S. Pat. No. 8,522,719 on Sep. 3, 2013.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but rather should be considered to include all embodiments and methods within the scope and spirit of the invention as claimed.

### DRAWINGS

FIG. 1. The receptacle bottom of the disposable pet toilet unit (10) and the pad of living grass (11) that is placed into the unit's receptacle bottom.

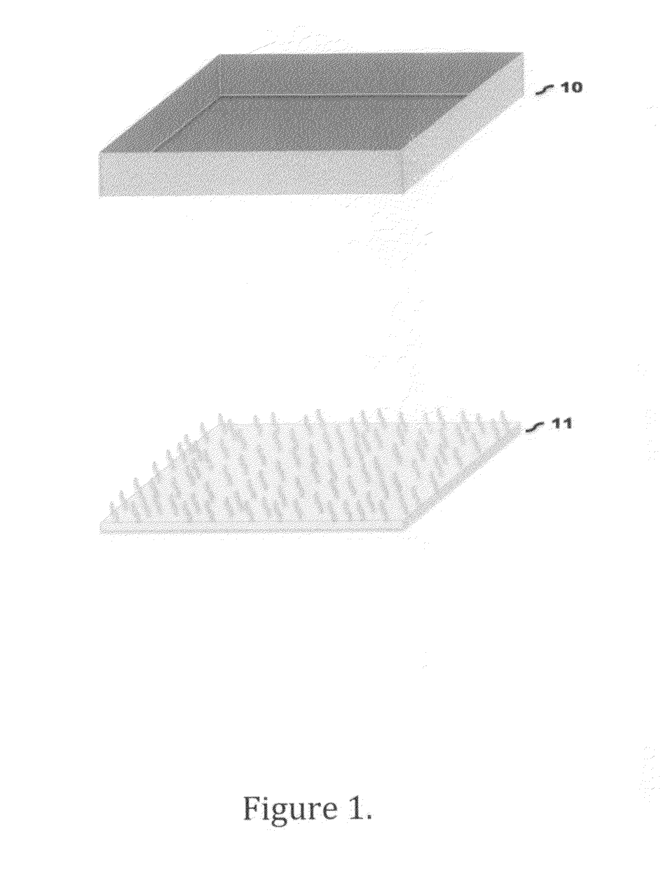

FIG. 2. The pet toilet's receptacle bottom when fitted with the pad of living grass (12). A view of the protective outer sleeve in a vertical position (13). A view of the protective outer sleeve when placed in a horizontal position (14).

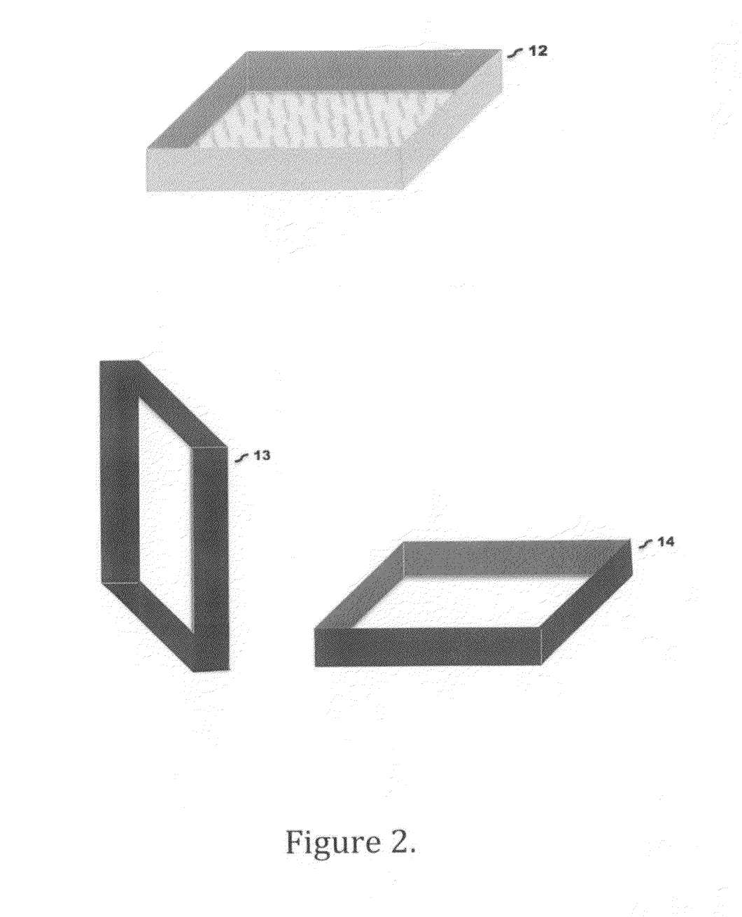

FIG. 3. The pet toilet unit's receptacle bottom (10) when it is fitted with a pad of living grass (12) and placed within the outer protective sleeve (14) in a manner in which the components of the pet toilet unit would be put together (15) for use by a pet.

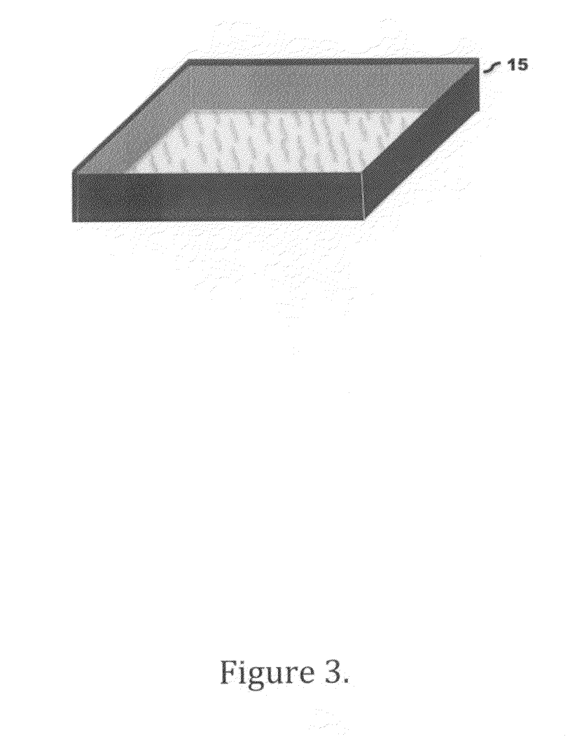

1. The construction of a reusable outer sleeve comprising a means for protecting a disposable pet toilet unit, which incorporates living grass, from the damage a pet can cause to the disposable bottom of said unit; and
Wherein said sleeve is constructed of durable material(s) that can withstand the chewing, tearing and other damage that pets can cause to the disposable bottom of said unit;
Wherein said sleeve is constructed having a shape and dimensions that will enable the sleeve to surround the exterior sides of the pet toilet unit so that the unit fits within the sleeve;
Wherein said sleeve is constructed to be at least the height of the pet toilet unit so that no parts or the exterior of said unit are exposed to chewing, gnawing, or tearing by a pet;

2. The reusable outer protective sleeve according to claim 1 wherein said sleeve is constructed for at least one user as a means of protecting the exterior side walls of at least one disposable pet toilet unit which incorporates living grass; and

3. The reusable outer protective sleeve according to claim 1 wherein the a new disposable pet toilet unit can be slipped into the sleeve before the unit is used by a pet, and wherein a pet toilet unit may be removed from the sleeve when it is time to dispose of the unit.

4. The reusable outer protective sleeve according to claim 1 wherein the sleeve can be retained by at least one user for repeated use with disposable, living-grass pet toilet units whose dimensions are compatible with the dimensions of the sleeve.
